(19) United States
(12) Patent Application Publication
(10) Pub. No.: US 2004/0142711 A1
(43) Pub. Date: Jul. 22, 2004

(54) Method, device and system for automated synchronization between terminals

(75) Inventors: Hannu Mahonen, Tampere (FI); Riku M. Mettala, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/661,779

(22) Filed: Sep. 11, 2003

(30) Foreign Application Priority Data
Sep. 11, 2002 (WO) PCT/IB02/03657

(51) Int. Cl. H04B 7/005; H04B 7/01; H04B 7/015; H04B 15/00

(52) U.S. Cl. 455/502; 455/552.1

(57) ABSTRACT

The present invention provides a method for automated synchronization between a first and a second mobile terminal. A plurality of individual modes are provided to be operable with an operation mode of the first device. According to an embodiment of the invention, the individual modes corresponds to profile settings which are responsible for defining the operational state of for example a mobile phone at receiving a call or a message, i.e. to ring and to vibrate in case of receiving a call or to vibrate only. The user is allowed to extend the individual modes such that at asserting an extended individual mode a synchronization process to automatically activated. According to another embodiment of the invention, the synchronization process is performed directly between these two terminal devices in a device-to-device manner via a local communication connection.

### CROSS-REFERENCE TO RELATED APPLICATION

This application claims priority from International Application PCT/IB02/03657 filed Sep. 11, 2002 under 35 U.S.C. § 119.

### BACKGROUND OF THE INVENTION

1. Technical Field

The present invention relates to synchronization of data between terminal devices, and in particular the invention relates to an automated device-to-device synchronization in conjunction with operational modes operable with at least one of the terminal devices.

2. Discussion of Related Art

Mobile terminal devices are widespread within the population and acceptance of use is rapidly growing at all levels of society. In the future an increasing number of users will own and/or use several mobile terminal devices subsequently or even in parallel. For example, each of the several used mobile terminal devices is dedicated to a specific use such as a mobile communication handheld or a mobile communication enhanced personal digital assistant (PDA) for business use and a mobile phone of light weight and small dimensions for personal use or for situations in which a large and/or weighty device is bothering. The multiple use of several mobile terminal devices raises the problem that information entered into a currently used one has to be made available to each of the others in order to provide a fluent exchange in the use of the different mobile terminal devices by a user.

Information stored in an electronic device to be made available to another electronic device relates to synchronization of data. The synchronization of data is a well known concept and technique for users, respectively, having at least two different electronic devices in use and processing the same kind of data with these electronic devices. In general, synchronization takes place between a terminal device (e.g., a mobile phone) and a server device (e.g., an application in a local PC or a dedicated synchronization server). Data of terminals, such as portable computers, PDA terminals (personal digital assistant), mobile stations or pagers, can be synchronized with network applications, applications of desktop computers or with other data stores of the telecommunications system, wherein the term data store should be understood as broad as possible, i.e. shall cover arbitrary sets of data. In particular, data of calendar, contacts and e-mail applications are typically synchronized.

Synchronization has been based on the use of different manufacturer-specific protocols which are incompatible. This restricts the use of terminal or data types and often causes troubles to the user. In mobile communication, in particular, it is important that data can be retrieved and updated regardless of the terminal and application used.

To improve synchronization of application data, a language known and referred to as synchronization markup language (SyncML) has been designed, which is based on the extensible markup language (XML). By using a SyncML synchronization protocol, which employs messages in the SyncML format, data of any application can be synchronized between networked terminals and a network server of any kind. The SyncML synchronization protocol works both in wireless and in fixed networks and supports several transmission protocols. The above presented SyncML synchronization technology addresses preferably the synchronization of data stores or databases, respectively. The SyncML synchronization technology offers a flexible and effective method to update data store contents relating to different applications.

### DISCLOSURE OF INVENTION

An object of the invention is to provide a synchronization of information between at least two mobile terminal devices. The synchronization is to be performed on changing the use of one mobile terminal device to another one in a direct device-to-device manner.

The object of the invention addresses the migration of use of mobile terminal devices owned and used simultaneously (i.e. subsequent in time) by a single owner, which shall be denoted as the migration of use in case of multiple device ownership. The automated synchronization initiated by a user wishing to use another mobile device of his several owned ones offers a fluently and seamless exchange in use within the multiple mobile terminal devices and guarantees up-to-date information of the mobile terminal device which is newly in use after migration. Therefore, the mobile terminal device currently in use and the mobile terminal device to be used from then on synchronize necessary and required information directly in a device-to-device manner. The device-to-device synchronization itself is operated in an simple and intuitive manner to facilitate the migration between the multiple owned mobile terminal devices.

The object of the invention is achieved with a method for automated synchronization between a first mobile terminal device and a second mobile terminal device, corresponding devices adapted to perform embodiments of the aforementioned method, a corresponding system having two mobile terminal devices that together carry out automated synchronization as a system level embodiment of the aforementioned method, and computer programs and software tools based on the aforementioned method.

According to an embodiment of the invention, a method for automated synchronization between a first mobile terminal device and a second mobile terminal device is provided. In order to operate accordingly, at least one user input is received. The at least one user input enables the user to select one individual mode from a plurality of individual modes. Each individual mode of the plurality thereof is operable as an operation mode which determines and controls the operation of the mobile terminal device, i.e. provides for a present operational state of the mobile terminal device. The operation of the mobile terminal device can be adapted to requirements of a user by employing different individual modes as operating modes whereas the different individual modes are pre-defined and adjusted to the different requirements of the user. The previously selected individual mode is asserted as an operation mode of the mobile terminal device. The selected individual mode may contain a command to initiate an automatic synchronization of information in-between the first terminal device and the second terminal device and comprises therefore pre-defined information relating to the synchronization operation, i.e. synchronization settings. The synchronization operation of synchronizing information comprised in both the first mobile terminal device and the second mobile terminal device is performed automatically in accordance with synchronization settings.

According to an embodiment of the invention, the one selected individual mode further includes a command triggering a taking the first mobile terminal device out of service and after the synchronization operation has been finished the first mobile terminal device is accordingly switched off.

According to an embodiment of the invention, the synchronization process of synchronizing information between the first mobile terminal device and the second mobile terminal device comprises an examination if the second mobile terminal device is available for performing the synchronization process, i.e. determining if the second mobile terminal device is connectable and ready to synchronize. In case that examination is successful the synchronization process of synchronizing information between the first mobile terminal device and the second mobile terminal device is operated as aforementioned.

According to an embodiment of the invention, the one selected individual mode once activated initiates an immediate synchronization operation.

According to an embodiment of the invention, the one selected individual mode once deactivated initiates an immediate synchronization operation.

According to an embodiment of the invention, the activation and the deactivation of the one selected individual mode comprises either a switching on or a switching off of the first terminal device.

According to an embodiment of the invention, the at least one received user input initiates a switching on of the first mobile terminal device. Such a user input may be generated by a user operating a power on/off switch of the first mobile terminal device. The at least one received user input further initiates a selecting of said one selected individual mode containing a command to initiate the automated synchronization.

According to an embodiment of the invention, the at least one received user input initiates a switching off of the first mobile terminal device. Such a user input may be generated by a user operating a power on/off switch of the first mobile terminal device. The at least one received user input further initiates a selecting of said one selected individual mode containing a command to initiate the automated synchronization and finally after the synchronizing operation the first mobile terminal device is switched off.

According to an embodiment of the invention, each of the plurality of individual modes comprises profile information. The profile information are related to the behavior of the first mobile terminal device at certain situations, for example receiving a call, receiving a message etc. The behavior of the first mobile terminal device is related to the operational state thereof. The profile information including at least one property of a group comprising ringing tone settings, ringing tone volume settings, alert type settings, vibrating alert settings, message alert settings, keypad tones settings, warning tones settings, event alert settings, call divert settings, switching on/off settings.

According to an embodiment of the invention, the information relating to the automated synchronizing and pre-defined synchronization properties, respectively, comprises information relating to properties including at least one of a group comprising information relating to data specifications to be synchronized, information relating to application specifications of which data is to be synchronized, information relating to one or more data storage places, time information relating to preceding synchronization events (e.g. for incremental/differential synchronization) and to schedules, addressing information of the second mobile terminal device, authentication information, information relating to a communication connection to be used for synchronization as well as information about an environment or a surrounding, respectively. The environment defines a local place at which the synchronization process is performed, wherein the local place may designate places like the office or the home of the user. The information about the environment may include inherently anyone or several of the above mentioned synchronization properties.

According to an embodiment of the invention, the synchronization is operated via a local communication connection.

According to an embodiment of the invention, the synchronization is operated in a device-to-device manner.

According to an embodiment of the invention, the synchronization is based on the synchronization markup language (SyncML) standard.

According to an embodiment of the invention, the first mobile terminal device is able to communicate via a cellular communication network. Further, the second mobile terminal device may be also able to communicate via a cellular communication network. According to an embodiment of the invention, a software tool for automated synchronization between a first mobile terminal device and a second mobile terminal device is provided. The software tool comprises program portions for carrying out the operations of the aforementioned methods when the software tool is implemented in a computer program and/or executed.

According to an embodiment of the invention, there is provided a computer program product for automated synchronization between a first mobile terminal device and a second mobile terminal device. The computer program comprises program code portions directly loadable into a local memory of a processing device, a terminal device, a communication terminal device or a network device for carrying out the operations of the aforementioned methods when the program is executed thereon.

According to an embodiment of the invention, a computer program product is provided which comprises program code portions stored on a computer readable medium for carrying out the aforementioned methods when the program product is executed on a processing device, a terminal device, a communication terminal device or a network device.

According to an embodiment of the invention, a mobile terminal device for automated synchronization with another mobile terminal device is provided. The mobile terminal device comprises a plurality of individual modes operable as an operation mode of the mobile terminal device. Each individual mode of the plurality thereof operated as an operation mode determines and controls the operation of the mobile terminal device, i.e. provides for a present operational state of the mobile terminal device. The operation mode defines the behavior of the mobile terminal device at certain situations such as on receiving a call, on receiving a message etc. By asserting one individual mode out of the plurality thereof as the selected operation mode the operational state can be adjusted to different requirements. The mobile terminal device further comprises at least one actuator for enabling the user to select one individual mode out of the plurality of individual modes. The selecting of an individual mode comprises an asserting of the selected individual mode as the operation mode. Further a synchronization component for synchronizing of information and a communication interface for exchanging synchronization related information is implemented in the mobile terminal device. The synchronization component has access to information of a data storage of the mobile terminal device. The one selected individual mode contains a command to initiate the automated synchronization between the mobile terminal device and the other mobile terminal device. In consequence thereto, the synchronization component is activated to perform a synchronizing operation with the other mobile terminal device wherein the synchronizing operation is operated in accordance with synchronization settings. According to an embodiment of the invention, the one selected individual mode contains a command to initiate a switching off of the mobile terminal device. In consequence thereto, after the synchronizing operation has been finished the mobile terminal device is taken out of service.

According to an embodiment of the invention, the at least one actuator comprises a power on/off actuator for putting the mobile terminal device into service and for taking the mobile terminal device out of service.

According to an embodiment of the invention, the component for synchronizing performs the automated synchronization via a local communication connection in a device-to-device manner.

According to an embodiment of the invention, the mobile terminal device is able to perform the aforementioned method for automated synchronization between a first mobile terminal device and a second mobile terminal device, wherein the first mobile terminal device corresponds to the claimed mobile terminal device and the second mobile terminal device corresponds to the other mobile terminal device.

According to an embodiment of the invention, a system for automated synchronization between a first mobile terminal device and a second mobile terminal device is provided.

The first mobile terminal device comprise a plurality of individual modes operable as an operation mode of the first mobile terminal device. Each individual mode of the plurality thereof operated as an operation mode determines and controls the operation of the first mobile terminal device, i.e. provides for a present operational state of the first mobile terminal device. The operation mode defines the behavior of the first mobile terminal device at certain situations such as on receiving a call, on receiving a message etc. By asserting individual modes out of the plurality thereof as the operation mode the operational state can be adjusted to different requirements. The first mobile terminal device further comprises at least one actuator for selecting an individual mode out of the plurality of individual modes. The selecting of an individual mode comprises an asserting of the selected individual mode as the operation mode. Further a synchronization component for synchronizing of information and a communication interface of exchanging synchronization related information is implemented in the first mobile terminal device. The synchronization component has access to information of a data storage of the first mobile terminal device.

The second mobile terminal device comprises at least a synchronization component for synchronizing of information included in a data storage of the second mobile terminal device and a communication interface implemented therein.

The one selected individual mode contains a command to initiate the automated synchronization between the first mobile terminal device and the second mobile terminal device. In consequence thereto, the synchronization component of the first mobile terminal device is activated to perform a synchronizing operation with the second mobile terminal device wherein the synchronizing operation is operated in accordance with synchronization settings. The synchronization operation is operated via the communication interface of the first mobile terminal device and the communication interface of the second mobile terminal device.

According to an embodiment of the invention, the one selected individual mode contains a command to initiate a switching off of the first mobile terminal device. In consequence thereto, after the synchronizing operation has been finished the first mobile terminal device is taken out of service.

According to an embodiment of the invention, the at least one actuator of the first mobile terminal device comprises a power on/off actuator for putting the first mobile terminal device into service and for taking the first mobile terminal device out of service.

According to an embodiment of the invention, the synchronization component of the first mobile terminal device performs the automated synchronization via a local communication connection in a device-to-device manner in combination with the synchronization component of the second mobile terminal device.

According to an embodiment of the invention, the first mobile terminal device is a mobile terminal device according to the aforementioned mobile terminal device for automated synchronization with another mobile terminal device.

According to an embodiment of the invention, the first mobile terminal device is capable to perform the aforementioned method for automated synchronization between a first mobile terminal device and a second mobile terminal device.

### BRIEF DESCRIPTION OF THE DRAWING

The invention will be described in greater detail by means of embodiments with reference to the accompanying drawings, in which

FIG. 1 shows a schematic diagram illustrating a set of exemplary electronic devices between which synchronization of information can be operated;

FIG. 2 shows a flow diagram illustrating an operational sequence for automated synchronization between a first mobile terminal device and a second mobile terminal device according to an embodiment of the invention;

FIG. 3a shows a flow diagram illustrating an operational sequence for configuring an operation mode according to an embodiment of the invention;

FIG. 3b shows a flow diagram illustrating an operational sequence for configuring an synchronization profile to be used in combination with an operation mode according to an embodiment of the invention;

FIG. 4a illustrates two terminal devices synchronizing information with each other according to an embodiment of the invention; and

FIG. 4b shows a block diagram illustrating components of two terminal devices for performing an automated synchronization with each other according to an embodiments of the invention.

### BEST MODE FOR CARRYING OUT THE INVENTION

In the following, the embodiments of the invention will be described in a system supporting the SyncML synchronization standard without limiting the invention thereto. Information relating to the SyncML standard can be obtained from the SyncML Initiative providing publicly the full standard documentation. Same or equal parts, features and/or operations shown in the figures will be referred to using the same reference numerals.

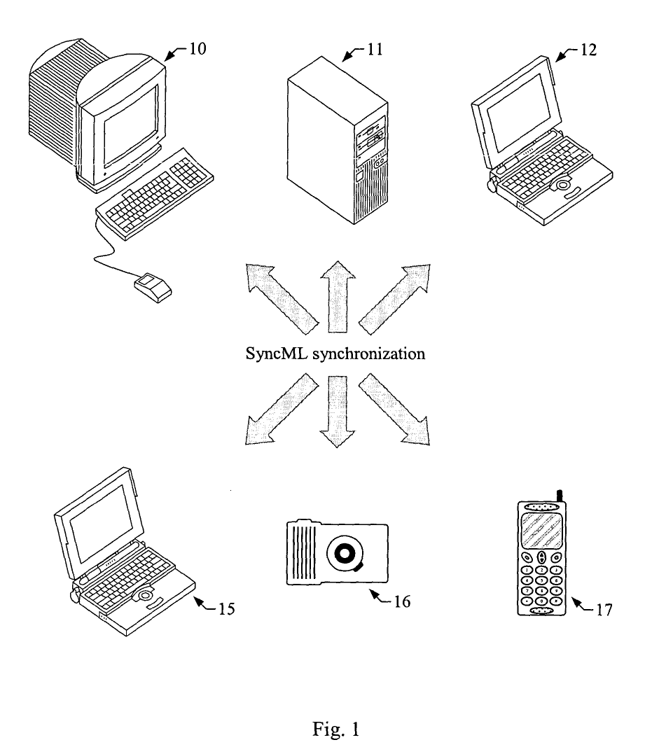

FIG. 1 shows a schematic diagram illustrating a set of exemplary electronic devices between which synchronization of information can be operated. A certain data store content of for example mobile terminals shall be harmonized with data store content provided by designated devices. Conventionally, mobile terminals act as synchronization clients harmonizing or synchronizing certain pre-defined data with the contents of a data store or several data stores provided by dedicated server devices. FIG. 1 illustrates a plurality of possible client devices and server devices for the synchronization operation. Typically, client devices are mobile stations like mobile phones 17 or personal digital assistants (PDA), mobile computers like notebooks 15, digital cameras 16 or personal computers (PC). Further, dedicated synchronization server devices may be desktop computers like a personal computer 10, a dedicated network server 11 or even a mobile computer like a notebook 12. It shall be noted that the client device functionality is not limited to mobile terminals as described above although the presented concept of synchronization is described in view of mobile terminals connected to dedicated serving devices.

Up to now, the limited processing capability of mobile terminals has caused such mobile terminals to act as client devices within synchronization processes and the evaluation which data has to be synchronized has been performed by server devices of increased processing capability such as dedicated synchronizing server, desktop computers, notebooks as aforementioned. The increasing processing capability and rising memory storage size of modern and future mobile devices, especially mobile communication devices of any kind, allows to implement device-to-device synchronization in-between mobile terminals which is an essential part of the concept of the present invention. The device-to-device synchronization is a direct synchronization between the participating mobile terminals for example via a local communication connection such as a Bluetooth connection. A detailed description follows below.

The information and data to be synchronized between mobile terminals are stored in the respective mobile terminal in a data store, respectively. It is noted that this term data store shall be understood as broad as possible, i.e. shall cover arbitrary set(s) of data provided by data storage(s) to be accessed. In particular, the sets of data relate to specific applications and may be organized to meet application specific requirements such as data of calendar applications, directory applications, e-mail applications and the like. Further, the arbitrary set(s) of data can be organized in one or more databases including data records providing data to be accessed.

The following flow diagram depicts operational sequences according to embodiments of the methods of the present invention. The depicted sequences of operations are just illustrative and not limiting thereto. Further realizations and implementations based on similar or related operational sequences are also possible.

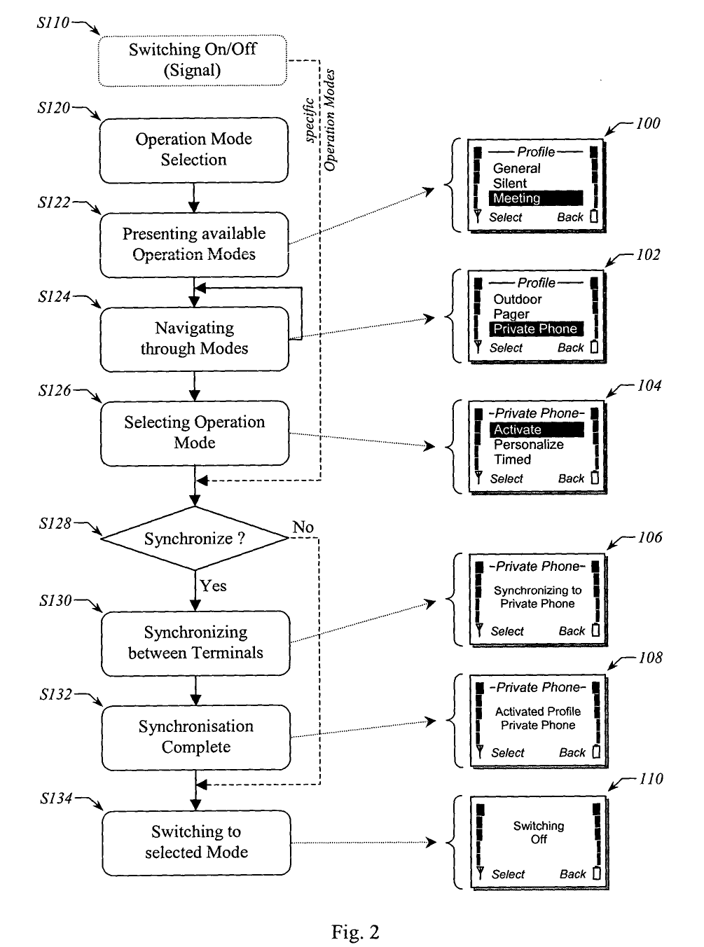

FIG. 2 illustrates an operational sequence for automated synchronization between a first and a second mobile terminal according to an embodiment of the invention.

In an operation S120, an operational sequence for selecting an individual mode to be operable as an operation mode with a mobile terminal device is started. The operational sequence is initiated by a user entered input received by the mobile terminal operated by the user. The user entered input initiates a switching of the currently operated operation mode to an individual mode operable as a new operation mode with the mobile terminal. The individual modes operable with the operation mode defines the behavior of the mobile terminal device. Therefore, the each of the available individual mode comprises a plurality of properties, settings and information, respectively, relating to a certain function of the mobile terminal device.

According to an embodiment of the invention, the user entered input initiates a presentation of a set of individual modes operable as operation mode with the mobile terminal device allowing a user to select an appropriate and/or desired one.

In an operation S122, a set of individual modes is displayed to the user. The presentation of the set of individual modes is displayed by a textual or graphical user interface via a display of the mobile terminal device to the user. The presentation of the individual modes can be activated by selecting an item of a user interface which is to be activated by the aforementioned user entered input. Further, a certain key can be reserved for activating the presentation of the individual mode, for example the power-on/off key may be dedicated for activating the operational sequence for presenting several individual modes to a user and allowing the user to select an individual mode.

Alternatively, the presentation of the set of individual modes is operated by an audio input controlled user interface capable to receive and interpret speech input or voice input of a user, respectively. That is, instead of receiving an input operable with selecting keys by a user the user interface receives a voiced or spoken audio sequence of the user, respectively, which is analyzed by a speech recognition component comprised in the mobile terminal device and which results in accordance with the speech or voice analysis in one or several instructions controlling the user interface similar to a key controlling of the user interface. The following description is based on a key controlled user interface but not limited thereto. The transition of the controlling of the user interface form being key controlled to being voice/speech controlled is apparent to those skilled in the art.

In an operation S124, the user is allowed to browse through the set of individual modes. The user navigates through the set of individual modes for example by operating navigation keys to navigate through the set of individual modes presented by the user interface. The set of individual modes may be displayed as a list of designations associated with the set of individual modes. The operation S124 is repeated until the user selects one of the presented set of individual modes. The navigating through the set of individual modes can comprise a scrolling of the displayed information or a refreshing of the displayed information relating to the set of individual modes or the list of designation associated with the set of individual modes, respectively.

In an operation S126, a further user entered input is received by the mobile terminal device which indicates a selection of one individual mode of the set of individual modes to be operated as an operation mode.

According to an embodiment of the invention, the set of individual modes is a set of profile modes or profiles, respectively. The profiles define the behavior of the mobile terminal device onto certain events and conditions. For example, the profiles define the behavior of the mobile terminal device at receiving an incoming call (ringing tone, volume, vibrating on/off and the like), at receiving an incoming short message (alert tone, volume, vibrating on/off and the like) etc. Further examples are given below.

In an operation S128, it is checked if the user selected individual mode comprises synchronizing information with an another mobile terminal device. In case synchronizing is comprised the operational sequence is continued with operation S130 otherwise the operational sequence is continued with operation S134.

In an operation S130, the desired synchronizing of information with a further mobile terminal device is initiated. The information about the synchronization process to be operated are pre-defined in a prior synchronizing configuration process. The information about the synchronization comprises for example information about the identity of counterpart mobile terminal device, authentication information, information about the data and application related data to be synchronized, respectively, the carrier or barrier to be employed for synchronizing etc.

The initiating of the synchronizing comprises a checking of the availability of the synchronization counterpart mobile terminal device. In case the counterpart mobile terminal device is not available for synchronizing the synchronizing process is aborted and an error message may be displayed to the user.

Information is synchronized between the mobile terminal device in use and the counterpart mobile terminal device. The synchronization is operated device-to-device, i.e. the operations necessary to synchronize the information of the both participating mobile terminal devices are operated at themselves without participating a further dedicated synchronizing server.

In an operation S132, the synchronizing information is completed.

In an operation S134, switching of the operation mode of the mobile terminal device in accordance with the selected individual mode is continued. That is, the operation mode of the mobile terminal device is configured in accordance with further settings associated with the selected individual mode. Alternatively, the selected individual mode described above includes only information relating to the synchronizing process. That is, the operation mode of the mobile terminal device is configured in accordance with a previously active (valid) individual mode which for example primarily concerns the event related signaling settings of the mobile terminal device.

In the following, the above illustrated operational sequence will be explained in combination with examples. These examples are based on the assumption that a user owns and uses two different mobile phones, a business phone such as a mobile communication handheld and a low weighted and small sized private phone. The user for example wishes that data of one or several applications is synchronized each time the user changes use between the mobile phones. For example, the data for the calendar application comprised in both phones shall be always up to date, i.e. always synchronized.

### EXAMPLE 1

Synchronizing information between a private mobile phone and a business mobile phone. The first example will be described in conjunction to the screen content illustrations depicted in FIG. 2. Each of the screen content illustrations is associated with an operation of the operational sequence described above.

The present situation is that the user currently operates the business phone and wishes to change use to the private phone.

Screen content illustration 100 depicts a user interface presenting a selection of profiles out of a set of profiles. This presentation is initiated by a user input e.g. by operating a certain profile selecting key such as the power-on/off key. The presented individual modes comprise as example typical profiles such as “general”, “silent” and “meeting” which are all associated with a certain behavior (operational state) of the mobile phone. For example, the mobile phone operated with the “silent” profile as operation mode does not ring at receiving an incoming call, does not signalize an incoming short message to the user etc., whereas a mobile phone operated with the “meeting” profile as operation mode indicates an incoming call and an incoming short message by vibrating or by making a peeping sound. The screen content illustration 100 corresponds to the description of operation S122.

Screen content illustration 102 depicts a user interface presenting a further selection of profiles out of the set of profiles after one or several navigation operation performed by user navigation inputs. Here, a profile designation labeled as “private phone” is displayed to the user. This profile is pre-defined by the user and comprises instructions to initiate the synchronizing of data with the private phone as described above and as desired by the user. The screen content illustration 102 corresponds to the description of operation S124.

Screen content illustration 104 depicts a user interface presenting available menu items in consequence on the prior user selection of the profile “private phone” to be selected and initiated by one or more further user inputs. The menu item “activate” instructs the presently operated business phone to assert the settings defined by the profile “private phone”. The menu item “personalize” allows a user to modify the settings of the profile whereas the menu items “timed” allows a user to automate the activation of the profile “private phone” at a certain time. The menu item “personalize” and “timed” are just illustrative. The user selects the entry “activate” to activate finally the profile “private phone”. The screen content illustration 104 corresponds to the description of operation S126.

Screen content illustration 106 depicts status information during the synchronizing process of data between the business mobile phone and the participating private phone as instructed by the selected profile “private phone”. Prior to the performing of the synchronizing operation the availability of the private phone has been checked and for example authentication information has been exchanged to ensure that the synchronization is allowed. The synchronizing process may additionally require an entering of information. For example, specific authentication information such as a log-in phrase and/or a corresponding password or a personal identification number (PIN) is requested at each time the synchronizing process is operated to prevent unauthorized use of this feature. The screen content illustration 106 corresponds to the description of operation S130.

Screen content illustration 108 depicts a status information informing the user that the synchronizing process has been completed and the profile “private phone” is now activated (asserted). The screen content illustration 108 corresponds to the description of operation S132 and operation 134, respectively.

Screen content illustration 110 depicts a status information informing the user that the business phone is finally automatically switched off. This switching off of the business phone is pre-defined in and part of the settings associated with the profile “private phone”. By this way the user is sure that the data of the applications entered during use of the business phone is now also available to the private phone since the data has been synchronized. Finally, the user can now take the SIM (subscriber identity module) card from the business phone to the private phone, if such would be appropriate or applicable. The screen content illustration 110 corresponds to the description of operation S134.

### Switching On/Off

The operation mode of the mobile terminal device is also determined by the switching on and switching off of the mobile terminal device. That is, a switching on of the mobile terminal device activates a certain switching on mode operable with the operation mode which comprises one or more instructions triggering synchronizing of information with a counterpart mobile terminal device. Analogously, a switching off of the mobile terminal device activates a certain switching off mode operable with the operation mode which comprises one or more instructions triggering synchronizing of information with a counterpart mobile terminal device.

In an operation S110, this is illustrated in combination with the above described operational sequence. In case of receiving a user entered signal triggering a switching on or a switching off of the mobile terminal device corresponding specific modes are automatically selected (activated, asserted). The specific modes are comparable with the individual modes operable with the operation mode of the mobile phone. The user is allowed to pre-define operations to be executed in conjunction with these specific modes. That is, after receiving of such a signal the operational sequence is continued with operation S128, checking if a synchronization has to be performed during the switching on process or the switching off process of the mobile terminal device.

### EXAMPLE 2

### Switching Off

The present situation is that the user currently operates the business phone and wishes to change use to the private phone. With respect to an embodiment of the invention the switching off mode comprises a command to trigger synchronizing of the above mentioned application related data. In order to initiate the synchronizing operation the user operates the power-on/off key to enter a respective signal instructing the business phone to initiate the shut down process including the operation in accordance with the switching off mode.

In accordance with the aforementioned operation S110, the operational sequence is continued directly with operation S128 without the presentation of profiles to be selected as described in operations S122 to S126 illustrated by screen content illustrations 100 to 104. Possible status information of the synchronization process can bee seen in screen content illustrations 106 to 110.

In example 2 the synchronization between the business phone and the private phone is automatically initiated on switching off of the business phone, whereas in contrast thereto in example 1 the synchronization between the business phone and the private phone is initiated on selecting the profile “private phone” which also switches off finally the business phone.

### EXAMPLE 3

### Switching On

The present situation is that the user currently operates the business phone and wishes to switch in use to the private phone. With respect to an embodiment of the invention the switching on mode comprises a command to trigger synchronizing of the above mentioned application related data. In order to initiate the synchronizing operation the user operates the power-on/off key to enter a respective signal instructing the private phone to initiate the power on process including the operation in accordance with the switching on mode.

In accordance with the aforementioned operation S110, the operational sequence is continued directly with operation S128 without the presentation of profiles to be selected as described in operations S122 to S126 illustrated by screen content illustrations 100 to 104. Possible status information of the synchronization process are analogously to those depicted in the screen content illustrations 106 and 108.

After completing of the synchronization the mobile terminal device resumes to the individual operation mode concerning the signaling of events of the mobile terminal device which has been active (valid) during the preceding operation thereof.

In example 3 the synchronization between the private phone and the business phone is automatically initiated by switching on the private phone, whereas in contrast thereto in example 1 the synchronization between the business phone and the private phone is initiated on selecting the profile “private phone”.

The following operational sequences relate to configuration of an individual mode operable with the operation mode of the mobile terminal device and configuration settings of a synchronizing operation which can be initiated by an activation of an individual mode. Both configurations are to be performed prior to the operational sequence described with reference to FIG. 2.

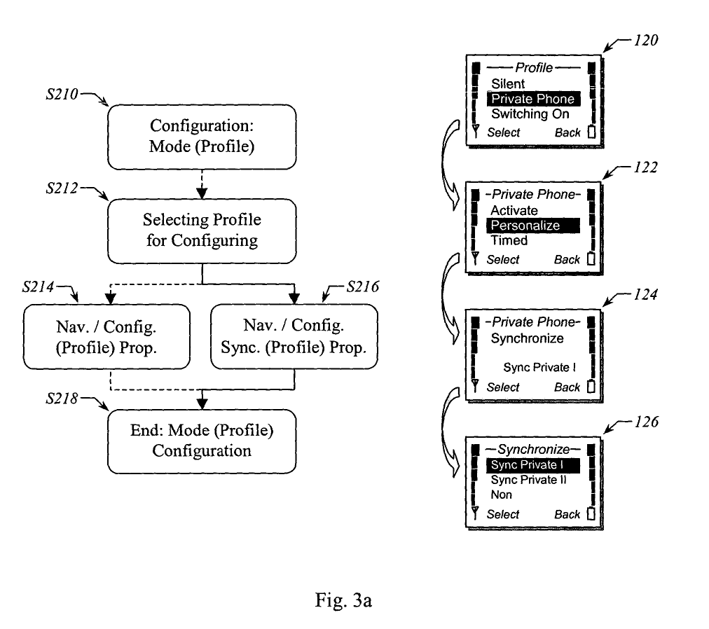

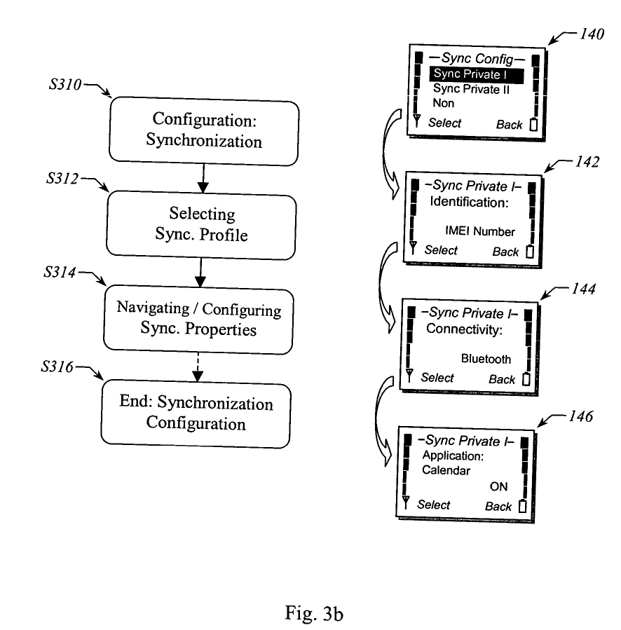

FIG. 3a illustrates an operational sequence for configuring an individual mode operable with the operation mode of a mobile terminal device according to an embodiment of the invention.

In an operation S210, the configuring of an individual mode operable with the operation mode of a mobile terminal device is initiated. The configuring is initiated by receiving a user entered input, for example by selecting a menu item dedicated to configure individual modes and displayed by the means of a textual or graphical user interface supporting the operation of the mobile terminal device.

In an operation S212, the individual mode is selected analogously to the individual operations S120 to S126 described in FIG. 2. Comprehensively, a user input is received activating a displaying of a set of individual modes. The set of individual modes are presented to the user to allow the user to select one of those presented. The user is able to navigate through the displayed set of individual modes and a further user entered input indicates a selected individual mode. Moreover, the user is also allowed to define a new individual mode to be a new member of the set of individual modes after the completion of the configuring of the new individual mode.

The screen content illustration 120 represents a possible screen content of a user interface in analogy to operation S212 shown in FIG. 3a, corresponding to operations S122 and S126 and related to screen content illustration 102 shown in FIG. 2.

As aforementioned and according to an embodiment of the invention, the set of individual modes is a set of profile modes or profiles, respectively. A profile defines the behavior of the mobile terminal device onto certain events and conditions. Therefore, the screen content illustration 120 depicts an exemplary selection of profiles, a “silent” profile, a “private phone” profile and a “switching on” profile. The pager profile relates to a signaling profile mode of the mobile phone, whereas both the “private phone” profile and the “switching on” profile relate to a synchronizing profile mode in accordance with the concept of the present invention. The principle differences between a signaling related profile and a synchronizing related profile will be apparent with reference to the following description.

The screen content illustration 122 represents a possible screen content of a user interface analogous to operation S126 and related to screen content illustration 104 shown in FIG. 2. But here, the menu item “personalize” shall be selected in order to configure or adapt (modify) the configuration properties of the profile “private phone”, respectively.

In accordance with the kind of profile, i.e. signaling related profile or synchronizing related profile, the operational sequence continues with an operation S214 or an operation S216. The operation S214 relates to the navigating through signaling options (signaling settings) of the mobile terminal device and configuring thereof, whereas the operation S216 relates to the navigating through synchronizing options (synchronization settings) of the mobile terminal device and configuring thereof.

In the operation S214, the user is allowed to navigate through the properties configurable by user input. According to an embodiment of the invention the profile definitions known from mobile communication devices, especially mobile phones, comprises for example at least a selection of the signaling settings relating to events occurring at the mobile terminal device, comprising:

incoming call alert settings,

ringing tone settings;

ringing tone volume settings;

vibrating alert settings;

message alert settings;

keypad tones settings;

warning tones settings;

alert for certain groups of callers settings;

call divert settings; and

switching off settings.

Each of the above presented settings is configurable by assigning one or more sub-settings or values entered by a user or selected from a pre-defined set of sub-settings or values.

In the operation S216, the user is allowed to select synchronization settings i.e. to define a synchronization profile to be part of the selected individual mode or the profile, respectively. Such an synchronization related profile comprises a plurality of synchronization related settings the configuration of which is described below with reference to FIG. 3b.

The screen content illustrations 124 and 126 show possible screen contents of a user interface for including a pre-defined synchronization profile into the example profile “private phone”. In illustration 124 the user interface offers a menu item for defining the synchronizing settings. At a user selection a set of synchronization profiles are presented in illustration 126 to the user which allows him to select one of it.

The navigating and configuring operations S214 and S216 for navigating through the plurality of properties included in an individual modes or profiles available for configuration, respectively, can be repeated as often as necessary until the configuration meet the requirements set by the user.

A more detailed description of the individual profile mode “Private Phone” has been given with reference to example 1 and a detailed description of the individual mode “Switching On” has been given with reference to example 3, both explained in combination with the description of FIG. 2.

In an operation S218, the configuration of the individual mode or profile, respectively, is completed. The configured individual mode or profile can be now activated as described with reference to FIG. 2.

FIG. 3b illustrates an operational sequence for configuring an synchronization profile to be used in combination with an operation mode according to an embodiment of the invention. The example operational sequence illustrated in FIG. 3a allows to include a pre-defined synchronization profile into an individual mode or profile, respectively. The operational sequence shown in FIG. 3b relates to a possible operational sequence to configure or adapt (modify) such an synchronization profile to meet requirements set by a user.

In an operation S310, the configuring of synchronization profiles is initiated. The configuring is initiated by receiving a user entered input, for example by selecting a menu item dedicated to configure synchronization profiles and displayed by the means of a textual or graphical user interface supporting the operation of the mobile terminal device.

In an operation S312, a set of available synchronization profiles is present to the user enabling to select one of the synchronization profiles for configuring or adapting (modifying), respectively. The selecting operation may be performed similarly to the operation S122 to S126 relating to the presentation and selection of an individual mode of a set of individual modes. Comprehensively, a user input is received activating a displaying of a set of synchronization profiles. The set of synchronization profiles are presented to the user enabling the user to select one of the presented one. The user is able to navigate through the displayed set of synchronization profiles and a further user entered input indicates a selected synchronization profile. Moreover, the user is also allowed to define a new individual mode to be a new member of the set of synchronization profiles after the completion of the configuring of the new individual mode.

The screen content illustration 140 represents a possible screen content of a user interface presenting a set of synchronization profiles available for configuring and adapting (modifying), respectively.

In an operation S314, the user is allowed to navigate through the properties configurable by user input. According to an embodiment of the invention the synchronization profile definitions known from synchronization processes for example based on a synchronization markup language (SyncML), comprises at least a selection of the properties relating to:

Identification of counterpart terminal device:

The identification defines the mobile terminal device which is considered for synchronizing data and information, respectively. The identification ensures simultaneously that the synchronization is only performed with this identified mobile terminal device. A number of identifications (not limiting) can be used for identifying uniquely a counterpart terminal device:

hardware provided identification, such as

SIM (subscriber identification module) card provided identification identifying worldwide uniquely each user of a cellular communication device,

IMEI (international mobile equipment identification) number identifying worldwide uniquely each cellular communication device,

MAC number identifying worldwide uniquely each network device and Bluetooth identification number identifying worldwide uniquely each Bluetooth component,

Authentication information:

In addition to an unique identification an authentication ensures an authenticated synchronization process. For example, the synchronization markup language (SyncML) provides the possibility to authenticate data synchronization transmissions. An authentication can be based on a transmission of a log-in phrase and/or a corresponding password or personal identification number (PIN).

Encryption (secured transmission):

An encrypted transmission of data is especially of interest when transmitting synchronization data via a wireless communication connection such as Bluetooth, wireless LAN (local area network), wireless local loop (WLL) etc. Data transmissions via such wireless communication connections can be tapped by a third unauthorized person. Encryption methods can be implemented directly by the communication carrier or may be additionally provided by encryption components of the state of the art.

Connectivity:

The connectivity enables to define which carrier is used for synchronizing data with the counterpart synchronizing device. According to an embodiment of the invention, the synchronization process is performed in a device-to-device manner via a local communication connections. Local communication connections can use wired connections such as USB cable, RS 232 cable or proprietary cables or wireless connections such as Bluetooth, WLAN (wireless local area network), IrDA (infrared connection), WLL (wireless local loop).

Type of synchronization:

The type of synchronization defines a way the synchronization is carried out. A first type of synchronization relates to a definition concerning a synchronization direction, i.e. two-way synchronization or one-way synchronization. In the two-way synchronization both participating synchronizing devices synchronize their data with the counterpart device, whereas in the one-way synchronization one synchronizing device reports modification of its data to the counterpart device but the counterpart device does not report any modifications of its data.

A second type of synchronization relates to a definition concerning total (slow) or incremental/differential (normal, fast) synchronization of data. In the slow synchronization all data are synchronized independently whether data are modified or not, whereas in the normal (fast) synchronization only data which have been modified since the last synchronization are synchronized which in comparisons with the slow synchronization results in a more economic and fast synchronization process. The normal (fast) synchronization type requires a logging of information about the preceding synchronization process (time/date information, change information etc.).

Applications/data content types:

The data or information to be synchronized is to be defined by the user, respectively.

For example, the definition can be based on applications each having its specific application related data which is desired to be synchronized. A user may define which application or applications are of interest and correspondingly which application related data is to be synchronized. A broad number of typical applications is eventually of interest for a user, such as contact application (contacts), calendar application (dates), business card application (business cards), browser application (bookmarks), SMS (short message service) application (messages), phone application (call registers), T9 text input support application (dictionaries) etc.

Alternatively, the data to be synchronized may be defined by a data content type. The data content type associates data to a specific application which is able to process this data. For example, a MIME (multipurpose internet mail extension) type definition can be employed for defining data of interest for synchronization. The MIME type definition is especially dedicated for identifying data and the corresponding related application.

The screen content illustration 142 presents a possible screen content of a user interface to define an IMEI number of the counterpart terminal device for identification purposes. The screen content illustration 144 presents a possible screen content of a user interface to define a connectivity, i.e. a communication connection, to exchange data for synchronization between the participating synchronizing terminal devices. And the screen content illustration 146 presents a possible screen content of a user interface to define data to be synchronized, here an application (the calendar application) is identified which means that the application related data is synchronized with the counterpart terminal device. Alternatively, in case that the calendar application is a VCalendar application the data to by synchronized may be defined by the MIME type “text/vcal” sequence.

Each of the above presented properties is configurable by assigning one or more sub-settings or values entered by a user or selected from a pre-defined set of sub-settings or values.

In an operation S316, the configuration of the synchronization profile is completed. The configured synchronization profile can be defined as a part of a profile as described with reference to FIG. 3a and a synchronization process is operated as described with reference to FIG. 2, being based on a configured synchronization profile.

It shall be noted that the herein described two-step configuration of synchronization profiles as embodied by the operational sequences referring to FIG. 3a and FIG. 3b is one possible solution according to an embodiment of the invention. The configuring of the synchronization setting as described with reference to FIG. 3b especially with reference to the operation S314 can be performed immediately in the operation S216 described with reference to FIG. 3a such that the defining of synchronization profiles as illustrated in the screen content illustration 126 depicted in FIG. 3a is obsolete.

The following diagrams are dedicated to the system of mobile terminal devices and components implemented in the mobile terminal devices necessary to operate the aforementioned method for automated synchronization according to an embodiment of the invention.

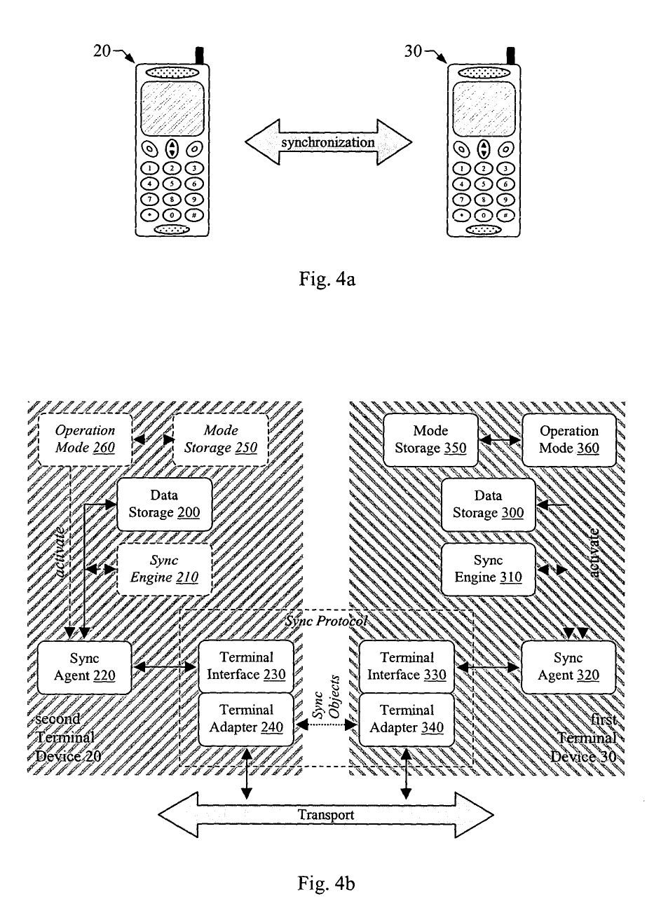

FIG. 4a illustrates two mobile terminal devices synchronizing information with each other according to an embodiment of the invention. The synchronization between the depicted terminal devices, in particular mobile communication devices, is operated according to an embodiment of the invention. The synchronization process itself is initiated by a user operating the first terminal device 30, alternatively, the synchronization process may be also initiated by a user operating the second terminal device 20.

A corresponding synchronization process in accordance with the SyncML protocol standard is established via an appropriate logical communication connection. The logical communication connection is provided by any communication networks in combination with transport protocols to which the synchronization protocol is adapted. A suitable communication network may be a local area network (LAN) or a wide area network (WAN) which may comprise the internet and an intranet of a company but also wire-based serial networks such as universal serial bus (USB) or standardized serial communication (e.g. RS-232). The participating synchronization devices may be also connected via a wireless communication network such as a mobile network supporting global system for mobile communication (GSM) services and/or supporting general packet radio services (GPRS), a third generation mobile communication network such as an universal mobile telecommunication system (UMTS) network, a wireless local area network (WLAN), short range radio communication network, such as a Bluetooth network, wireless local loop (WLL) or an infrared network (IrDA). The logical communication connection between the participating synchronization devices may be provided by a single communication network of the aforementioned type but also may be provided by several communication networks of the aforementioned types interconnected by dedicated network routing devices.

With respect to the SyncML protocol standard the SyncML synchronization protocol is implemented on the top of appropriate protocols in accordance with the type of employed communication network. Appropriate protocols on which top the SyncML synchronization protocol can be implemented are the hyper text transfer protocol (HTTP), the wireless session protocol (WSP) of the wireless application protocol (WAP) standard, the object exchange protocol (OBEX) used for cable connections, such as universal serial bus (USB) or RS-232, for short-range radio frequency connections (Bluetooth) or for infrared connections (IrDA), the transport control protocol/internet protocol (TCP/IP) stack and on top of the transport layer service which is offered by the e-mail protocol (e.g. simple mail transfer protocol, SMTP).

Transfer at the lower layer can be performed according to the underlying network using e.g. short messages SMS (short message service) or other signaling type transmission methods (e.g. USSD; unstructured supplementary service data), circuit-switched data calls, packet-switched data transfer services as well as paging message service, messages provided via cell broadcast and the like.

According to the inventive concept, the first terminal device 30 and second terminal device 20 perform the synchronization of information in a device-to-device manner which means that a direct local communication connection is established between these participating terminal devices 30 and 20. As mentioned above a number of local communication connections are state of the art and can be used for transmitting synchronization information. For example, a selection of wired local communication connections employable for such a data communication includes a USB (universal serial bus) interface, a RS 232 interface or a proprietary parallel or serial interface. Further, a selection of wireless local communication connections employable for such a data communication are for example includes a Bluetooth interface, a WLAN (wireless local areas network) interface, an IrDA (infrared communication) interface or a wireless local loop (WLL) interface but also proprietary wireless (especially radio) interfaces. As aforementioned, a broad number of applicable protocols can be transmitted via these different interfaces able to carry a synchronization protocol for operating the synchronization process.

FIG. 4b shows a block diagram illustrating components of two terminal devices for performing an automated synchronization with each other according to an embodiments of the invention.

The first terminal device 30 comprises a mode storage 350 including the aforementioned operation mode, the set of individual triodes operable with the operation mode and corresponding synchronization profiles. According to an embodiment of the invention, mode storage 350 includes the aforementioned operation mode and the set of profiles operable with the operation mode and corresponding synchronization profiles. At least one individual mode or profiles has associated a synchronization profile for synchronizing information with the second terminal device 20. The individual mode selected by the means of an actuator, switch key or any other inputting means (not shown) to be operated by the user is asserted to operate as the operation mode of the first terminal device 30, respectively. In case the asserted individual mode or profile instructs additionally by command an automated synchronization a synchronizing operation is triggered (activated) via managing synchronization agent 320 and communication components comprising a terminal interface 330 and a terminal adapter 340 in accordance with the activation of an individual mode or profile operable with the operation mode. The terminal interface 330 and the terminal adapter 340 are provided by the employed communication connection for the synchronization. The synchronization agent 320 is able to access a data storage 300, i.e. to retrieve data and to store (modify) data as required by the synchronization in-between the participation first terminal device 30 and second terminal device 20 and as defined by the properties in accordance with the synchronization profile valid for the synchronization process.

The counterpart second terminal device 20 comprises correspondingly communication components including a terminal interface 230 and a terminal adapter 240 analogous to the terminal interface 330 and terminal adapter 340 to be able to communicate with the first terminal device 30. A synchronization agent 220 of the second terminal device 20 is further able to manage the synchronization process with the first terminal device 30 and therefore is able to access a data storage 200 of the second terminal device 20, i.e. to retrieve data and to store (modify) data.

The synchronization process is operated by the means of a synchronization protocol which is based on the synchronization markup language (SyncML) according to an embodiment of the invention. The synchronization protocol implements synchronization objects which are exchanged between the first terminal device 30 and the second terminal device 20. The synchronization objects define and comprise information relating to the synchronization process and to the information to be synchronized, respectively. Synchronization agents 320 and 220 are implemented in both terminal devices 30 and 20, but one synchronization engine either synchronization engine 310 or synchronization engine 210 implemented in one of the terminal devices 30 or 20 is sufficient for performing the aforementioned synchronizing operation of information between the both terminal devices 30 and 20. The synchronization engine 310 or 210 is responsible for identifying or evaluating which information of the total information to be synchronized has been modified, added, deleted, new arranged and the like and hence has to be implemented in either the first terminal device 30 or the second terminal device 20 to achieve synchronized information in both the first terminal device 30 and the second terminal device 20.

As aforementioned, the first terminal device 30 comprises a mode storage 350, an operation mode 360, a data storage 300, a synchronization agent 320, a synchronization engine 310, a terminal interface 330 and a terminal adapter 340. The second terminal device 30 comprises as aforementioned a data storage 250, a synchronization agent 220, a terminal interface 230 and a terminal adapter 240. These components are necessary to perform the method for automated synchronization executed by the first terminal device 30 whereas the second terminal device 20 is not able to initiate an automated synchronization of the aforementioned kind according to this embodiment of the invention.

The illustration of FIG. 4b depicts a symmetrical arrangement of components implemented in the first terminal device 30 and second terminal device 20. According to another embodiment of the invention, the second terminal device 20 comprises additionally a mode storage 250, an operation mode 260, at least an actuator, a switch, a key or any other inputting means (not shown) operable by a user for select an individual mode or profile, respectively, and a synchronization engine 210 such that the second terminal device 20 is also capable to perform the aforementioned method for automated synchronization analogous to the first terminal device 30.

It will be obvious for those skilled in the art that as the technology advances, the inventive concept can be implemented in a different and broader number of ways. The invention and its embodiments are thus not limited to the examples described above but may vary within the scope of the claims.

1. Method for automated synchronization between a first mobile terminal device (30) and a second mobile terminal device (20), comprising:
receiving (S126) at least one user input;
selecting (S126) one individual mode in accordance with said at least one received user input;
wherein
said one selected individual mode contains a command to trigger said automated synchronization; and
performing a synchronizing operation (S130) between said first mobile terminal device (30) and said second mobile terminal device (20) in accordance with pre-defined synchronization settings.

2. Method according to claim 1, wherein
said one selected individual mode contains a further command to switch off said first mobile terminal device (30); and
switching off said first mobile terminal device (30) after completion (110) of said synchronizing operation.

3. Method according to claim 1, wherein the operation of performing said synchronizing operation comprises:
checking availability of said second mobile terminal device (20) for performing said synchronizing operation.

4. Method according to claim 1, wherein said one selected individual mode once activated triggers an immediate synchronizing operation.

5. Method according to claim 1, wherein said one selected individual mode once deactivated triggers an immediate synchronizing operation.

6. Method according to claim 4, wherein said activation comprises switching on said first terminal device (30).

7. Method according to claim 1, wherein said at least one user input triggers a switching on of said first mobile terminal device (30).

8. Method according to claim 1, wherein said at least one user input triggers a switching off of said first mobile terminal device (30).

9. Method according to claim 1, wherein said pre-defined synchronization settings comprise information relating to properties including at least one of a group comprising:
information relating to specific data to be synchronized;
information relating to specific applications of which data is to be synchronized;
information about a type of synchronization;
information relating to said second mobile terminal device;
authentication information;
information relating to a communication connection to be used for synchronization; and
information about an environment in which said synchronization is to be carried out.

10. Method according to claim 1, wherein said automated synchronization is performed via a local communication connection.

11. Method according to claim 1, wherein said automated synchronization information is performed in a device-to-device manner.

12. Method according to claim 1, wherein said automated synchronization is based on a synchronization markup language (SyncML) standard.

13. Method according to claim 1, wherein said first mobile terminal device (30) is a cellular communication device.

14. Software tool for automated synchronization between a first mobile terminal device and a second mobile terminal device, comprising program portions for carrying out the operations of claim 1, when said program is implemented in a computer program for being executed on a processing device, a terminal device, a communication terminal device or a network device.

15. Computer program product for automated synchronization between a first terminal mobile device and a second mobile terminal device, comprising loadable program code sections for carrying out the operations of claim 1, when said computer program is executed on a processing device, a terminal device, a communication terminal device or a network device.

16. Computer program product for automated synchronization between a first terminal mobile device and a second mobile terminal device, wherein said computer program product is comprising program code sections stored on a computer readable medium for carrying out the method of claim 1, when said computer program product is executed on a processing device, a terminal device, a communication terminal device or a network device.

17. Mobile terminal device for automated synchronization with another mobile terminal device, comprising:
a plurality of individual modes, each of said plurality of individual modes being operable as an operation mode with said mobile terminal device (30, 20), said operation mode controlling an operation of said mobile terminal device (30, 20);
at least one actuator for selecting one individual mode out of said plurality of individual modes;
a synchronization component (320, 220, 310, 210) for synchronizing of information stored in a data storage (300, 200); and
a communication interface (330, 340, 230, 240) for exchanging synchronization related information;
wherein
the one selected individual mode comprises a command to trigger said automated synchronization; wherein
said synchronization component (320, 220, 310, 210) is activated to perform a synchronizing operation with said other mobile terminal device (30, 20) via said communication interface (330, 340, 230, 240), said synchronizing operation is performed in accordance with pre-defined synchronization settings.

18. Mobile terminal device according to claim 17, wherein
said one selected individual mode contains a command to trigger a switching off; and
said mobile terminal device (30, 20) is switched off after completion of said synchronizing operation.

19. Mobile terminal device according to claim 17, wherein said at least one actuator comprises a power on/off actuator for triggering a switching on and a switching off of said mobile terminal device.

20. Mobile terminal device according to claim 17, wherein said component for synchronizing operates said synchronizing information via a local communication connection in a device-to-device manner.

21. Mobile terminal device according to claim 17, wherein said mobile terminal device is able to execute a method comprising the steps of:
receiving (S126) at least one user input;
selecting (S126) one individual mode in accordance with said at least one received user input;
wherein
said one selected individual mode contains a command to trigger said automated synchronization; and
performing a synchronizing operation (S130) between said first mobile terminal device (30) and said second mobile terminal device (20) in accordance with pre-defined synchronization settings.

22. System for automated synchronization, comprising
a fist mobile terminal device (30) including;
a plurality of individual modes, each of said plurality of individual modes being operable as an operation mode with said first mobile terminal device (30), said operation mode controlling an operation of said first mobile terminal device (30);
at least one actuator for selecting one individual mode out of the plurality of individual modes;
a synchronization component (320, 310) of said first mobile terminal device (30) for synchronizing of information stored in a data storage (300); and
a communication interface (330, 340) of said first mobile terminal device (30) for exchanging synchronization related information;
a second mobile terminal device (20) including:
a synchronization component (220, 210) of said second mobile terminal device (20) for synchronizing of information stored in a data storage (200); and
a communication interface (230, 240) of said second mobile terminal device for exchanging synchronization related information;
wherein
said one selected individual mode contains a command to trigger said automated synchronization; wherein
said synchronization component (320, 310) of said first terminal device (30) is activated to perform a synchronizing operation with said synchronization component (220, 210) of the second mobile terminal device (20) via said communication interface (330, 340) of said first mobile terminal device (30) and said communication interface (230, 240) of said second mobile terminal device (20), said synchronizing operation performed in accordance with pre-defined synchronization settings.

23. System according to claim 22, wherein
said one selected individual mode contains a command to trigger a switching off; and
said first mobile terminal device (30) is switched off after completion of said synchronizing operation.

24. System according to claim 22, wherein said at least one actuator comprises a power on/off actuator for switching on and switching off said first mobile terminal device.

25. System according to claim 22, wherein said component of said first mobile terminal device for synchronizing operates said automated synchronization via a local communication connection in a device-to-device manner with said component of said second mobile terminal device for synchronizing.

26. System according to claim 22, wherein said first mobile terminal device is a mobile terminal device comprising:
a plurality of individual modes, each of said plurality of individual modes being operable as an operation mode with said mobile terminal device (30, 20), said operation mode controlling an operation of said mobile terminal device (30, 20);
at least one actuator for selecting one individual mode out of said plurality of individual modes;
a synchronization component (320, 220, 310, 210) for synchronizing of information stored in a data storage (300, 200); and
a communication interface (330, 340, 230, 240) for exchanging synchronization related information;
wherein
the one selected individual mode comprises a command to trigger said automated synchronization; wherein
said synchronization component (320, 220, 310, 210) is activated to perform a synchronizing operation with said other mobile terminal device (30, 20) via said communication interface (330, 340, 230, 240), said synchronizing operation is performed in accordance with pre-defined synchronization settings.

27. System according to claims 22, wherein said first mobile terminal device is able to execute a method comprising the steps of:
receiving (S126) at least one user input;
selecting (S126) one individual mode in accordance with said at least one received user input;
wherein
said one selected individual mode contains a command to trigger said automated synchronization; and
performing a synchronizing operation (S130) between said first mobile terminal device (30) and said second mobile terminal device (20) in accordance with pre-defined synchronization settings.
